(19) United States
(12) Patent Application Publication
(10) Pub. No.: US 2007/0171122 A1
(43) Pub. Date: Jul. 26, 2007

(54) RADAR APPARATUS AND INTERFERENCE DETECTION METHOD

(75) Inventors: Masao Nakano, Kanagawa (JP); Kouichi Miyagawa, Hyogo (JP); Kanako Honda, Hyogo (JP); Yasuhiro Sekiguchi, Hyogo (JP)

Correspondence Address: FOGG & POWERS LLC, 10 SOUTH FIFTH STREET, SUITE 1000, MINNEAPOLIS, MN, 55402, US

(73) Assignees: FUJITSU TEN LIMITED, Hyogo (JP); FUJITSU LIMITED, Kanagawa (JP)

(21) Appl. No.: 11/627,137

(22) Filed: Jan. 25, 2007

(30) Foreign Application Priority Data
Jan. 25, 2006 (JP) 2006-16593

(51) Int. Cl. G01S 13/00; G01S 13/93

(52) U.S. Cl. 342/91; 342/70; 342/196; 342/89; 342/159

(57) ABSTRACT

A radar apparatus having a interference detection unit which computes an average value of received power from received signals corresponding to receiving waves received by the receiving antennas, and determines that interference has occurred when the difference between this average value and the average value of the previously computed received power is a threshold value or more. Moreover, in other interference detection method, the interference detection unit determines that interference has occurred when an average value of received power corresponding to a large distance is a threshold value or more. Furthermore, in other method, the interference detection unit determines that interference has occurred when a received power value is detected as a threshold value or more when a transmission wave is not transmitted from the transmission antenna.

### CROSS-REFERENCE TO RELATED APPLICATIONS

This application is based upon and claims the benefit of priority from the prior Japanese Patent Application No. 2006-16593, filed on Jan. 25, 2006, the entire contents of which are incorporated herein by reference.

### BACKGROUND OF THE INVENTION

1. Field of the Invention

The present invention relates to a radar apparatus and interference detection method for measuring the bearing and the like of a target from a reflected wave reflected on the target.

2. Description of the Related Art

There has conventionally been a radar apparatus, which outputs a transmission wave from a transmission antenna and receives a reflected wave reflected on a target to measure the bearing, distance, velocity and the like of the target. For example, the radar apparatus is mounted in a vehicle and used for preventing a collision with a vehicle in front.

In such the radar apparatus, interference may occur with, for example, an oncoming vehicle equipped with a different radar apparatus, wherein a transmission wave of the different radar apparatus cannot be distinguished (separated) from a reflected wave, which is obtained when the transmission wave of the former radar apparatus is reflected on a target, and thereby erroneous detection or the like is carried out. When such interference occurs, detection of the bearing and the like cannot be performed accurately on the target.

In the prior art, therefore, for example, there is an FM radar apparatus in which an interfered radio wave is eliminated to detect a true target by storing in a memory a spectrum of a beat signal at the time of a receiving mode, and correcting a spectrum of a beat signal that is obtained in a subsequent transmitting mode, on the basis of the previously stored spectrum (see Japanese Patent Application Laid-Open No. H5-240947, for example).

Further, there is disclosed an FM-CW radar apparatus in which whether interference occurs or not is determined by an interference detection unit, which mixes a transmitting signal with a part of a received signal by using a mixer and compares the magnitudes between an amplitude of an output signal of the mixer and a predetermined threshold value (see Japanese Patent Application Laid-Open No. 2002-168947, for example).

There is also disclosed an automotive radio wave radar in which the center frequency of a transmission wave is shifted periodically, then majority decision is performed among the positional information items of obstacles detected in respective frequencies, and a result that an erroneous obstacle is detected due to radio disturbance is eliminated (see Japanese Patent Application Laid-Open No. 2004-109046, for example).

Moreover, there is disclosed an FM-CW radar apparatus in which radio wave interference is prevented from occurring, by mixing a received signal with a local signal by means of a mixer, and delaying the phase of thus obtained output signal by two phases by means of a phase-modulated code that is obtained by time-delaying a phase-modulated signal outputted from a code generator by using a delay circuit (see Japanese Patent Application Laid-Open No. 2002-14159, for example).

However, in these conventional technologies, a separate circuit for phase modulation and the like is required in each radar apparatus. Moreover, complicate computation needs to be carried out in the radar apparatus, thus more throughput is required.

### SUMMARY OF THE INVENTION

With the foregoing in view, it is an object of the present invention to provide a radar apparatus and interference detection method that have simple configurations and are capable of accurately detecting interference without increasing the throughput.

To achieve the above object, one of a radar apparatus of the present invention having: a transmit antenna which transmits a transmit wave, a receive antenna which receives a receive wave including a reflected wave reflected on a target of the transmit wave; and an interference detection unit which judges that interference has occurred, when received power obtained by performing Fourier transformation on the receive wave received by the receive antenna changes by a threshold value or more.

Also the radar apparatus of the present invention, wherein the interference detection unit judges that interference has occurred, when a difference between an average value of the received power of the receive wave and an average value of the received power of the previously detected receive wave changes by a threshold value or more.

Furthermore, in the radar apparatus of the present invention, the interference detection unit computes the average values from received power within a frequency range in which the received power is stable.

Furthermore, in the radar apparatus of the present invention, the interference detection unit computes the average values from received power within a range other than the frequency range in which the received power is stable.

Furthermore, in the radar apparatus of the present invention, the interference detection unit judges that interference has occurred, when the interference detection unit detects, a predetermined number of times, that the amount of change is the threshold value or more.

Furthermore, in the radar apparatus of the present invention, the time between when the receive wave is detected by the receive antenna and when detection is performed as to whether the amount of change is the threshold value or more is the time required for preventing a collision between a vehicle equipped with the radar apparatus and other vehicle.

Also, in order to achieve the above object, one of an interference detection method of the present invention for a radar apparatus having a transmit antenna which transmits a transmit wave, and a receive antenna which receives a receive wave including a reflected wave reflected on a target of the transmit wave, the method comprising of the step of: judging that interference has occurred, when received power of the receive wave received by the receive antenna changes by a threshold value or more.

Furthermore, in order to achieve the above object, another radar apparatus of the present invention having a transmit antenna which transmits a transmit wave, a receive antenna which receives a receive wave including a reflected wave reflected on a target of the transmit wave; and an interference detection unit which determines that interference has occurred, when, of the receive waves received by the receive antenna, an average value of received power corresponding to a large distance from the radar apparatus is a threshold value or more.

Furthermore, in order to achieve the above object, another interference detection method for a radar apparatus having a transmit antenna which transmits a transmit wave, and a receive antenna which receives a receive wave including a reflected wave reflected on a target of the transmit wave, the method comprising the step of: judging that interference has occurred, when, of the receive waves received by the receive antenna, an average value of received power corresponding to a large distance from the radar apparatus is a threshold value or more.

Furthermore, in order to achieve the above object, another radar apparatus of the present invention having a transmit antenna which transmits a transmit wave, a receive antenna which receives a receive wave including a reflected wave reflected on a target of the transmit wave; and an interference detection unit which judges that interference has occurred, if a received power value, when the transmit wave is not transmitted from the transmit antenna, is a threshold value or more.

Furthermore, in order to achieve the above object, another interference detection method for a radar apparatus having a transmit antenna which transmits a transmit wave, and a receive antenna which receives a receive wave including a reflected wave reflected on a target of the transmit wave, the method comprising the step of: judging that interference has occurred, if a received power value, when the transmit wave is not transmitted from the transmit antenna, is a threshold value or more.

Furthermore, in order to achieve the above object, another radar apparatus of the present invention having: a transmit antenna which transmits a transmit wave, a receive antenna which receives a receive wave including a reflected wave reflected on a target of the transmit wave; and an interference detection unit which judges that interference has occurred when, of the receiving waves received by the receiving antenna, an average value of received power corresponding to a high-relative velocity range is a threshold value or more.

Furthermore, in order to achieve the above object, another interference detection method for a radar apparatus having a transmit antenna which transmits a transmit wave, and a receive antenna which receives a receive wave that includes a reflected wave reflected on a target of the transmit wave, the method comprising the step of: judging that interference has occurred, when, of the receive waves received by the receive antenna, an average value of received power corresponding to a high-relative velocity range is a threshold value or more.

According to the present invention, a radar apparatus and interference detection method that have simple configurations and are capable of accurately detecting interference without increasing the throughput can be provided.

### BRIEF DESCRIPTION OF THE DRAWINGS

FIG. 1 is a figure showing a configuration example of the radar apparatus according to the present invention;

FIG. 2A is a figure showing an example of a baseband signal at normal time;

FIG. 2B is a figure showing an example of a result of FFT at normal time;

FIG. 3A is a figure showing an example of the baseband signal at interference time;

FIG. 3B is a figure showing an example of a result of FFT at interference time;

FIG. 4 is a figure showing an example of a power average value at the normal time and at the interference time;

FIG. 5 is an example of a flowchart showing the operation of an interference detection unit;

FIG. 6 is a figure showing the relationship between received power and a distance;

FIG. 7 is an example of a flowchart showing the operation of the interference detection unit;

FIG. 8 is a figure showing the relationship between the received power and a frequency when transmission is not performed;

FIG. 9 is an example of a flowchart showing the operation of the interference detection unit;

FIG. 10 is a figure showing the relationship between the received power and a frequency;

FIG. 11 is an example of a flowchart showing the operation of the interference detection unit;

FIG. 12 is a figure showing an example of the case where the radar apparatus is mounted in a vehicle;

FIG. 13 is a figure showing another configuration example of the radar apparatus; and

FIG. 14 is a figure showing yet another configuration example of the radar apparatus.

### DESCRIPTION OF THE PREFERRED EMBODIMENTS

### Embodiment 1

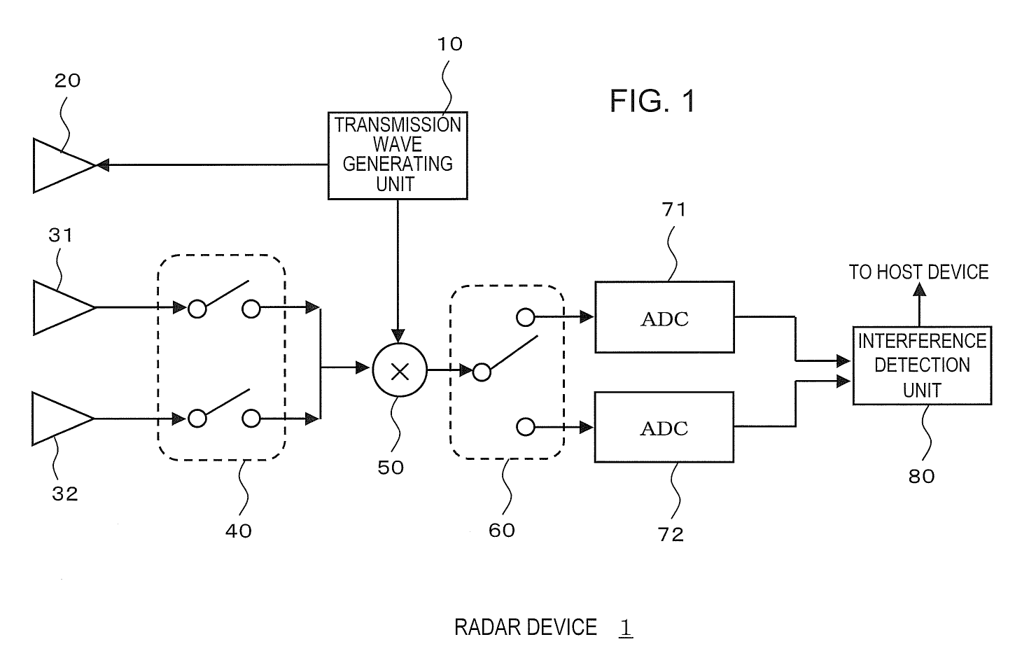

Preferred embodiments for carrying out the present invention are described hereinafter with reference to the drawings. FIG. 1 is a figure showing a configuration example of a radar apparatus 1.

The radar apparatus 1 has a transmission wave generating unit 10, a transmission antenna 20, first and second receiving antennas 31, 32, an antenna switching switch 40, a mixer 50, an output switching switch 60, first and second analog-digital converters (ADC) 71, 72, and an interference detection unit 80.

The transmission wave generating unit 10 generates a signal for forming a transmission wave which is transmitted from the transmission antenna 20. For example, a signal for forming a triangular wave is generated. The transmission wave generating unit 10 is constituted by an oscillator such as a VCO (Voltage Control Oscillator).

The transmission antenna 20 transmits a transmission wave on the basis of the signal generated from the transmission wave generating unit 10. It should be noted that, since the radar apparatus 1 transmits a transmission wave in the form of a FMCW (Frequency Modulated Continuous Wave), a transmission wave in the form of a triangular wave, which is frequency modulated, is transmitted from the transmission antenna 20.

The first and second receiving antennas 31, 32 receive a reflected wave reflected on a target. The two receiving antennas 31, 32 also receive interfered wave.

The antenna switching switch 40 switches an output signal that is outputted from either the first or the second receiving antenna 31, 32 so as to be outputted to the mixer 50. For example, ON and OFF are switched based on a control signal transmitted from a microcomputer. Of course, output signals from the both two switches may be switched so as to be outputted to the mixer 50.

The mixer 50 mixes an output signal from the antenna switching switch 40 with an output signal from the transmission wave generating unit 10. Thus obtained mixed signal is outputted to the output switching switch 60.

The output switching switch 60 is switched so that the mixed signal sent from the mixer 50 is outputted to the first ADC 71 or the second ADC 72. For example, ON and OFF of the switch are controlled to be switched based on the control signal transmitted from the microcomputer.

The first and second ADCs 71, 72 convert an output signal transmitted from the output switching switch 60 to a digital signal.

The interference detection unit 80 detects whether interference occurs in the digital signals outputted from the first and second ADCs 71, 72. Specifically, the interference detection unit 80 detects whether interference occurs in a receiving wave received by the first and second receiving antennas 31, 32, on the basis of the output signal from the first and second ADCs 71, 72. When interference occurs, the interference detection unit 80 informs a host apparatus of the occurrence of interference by outputting an output signal.

Next, an interference detection method of the interference detection unit 80 is described.

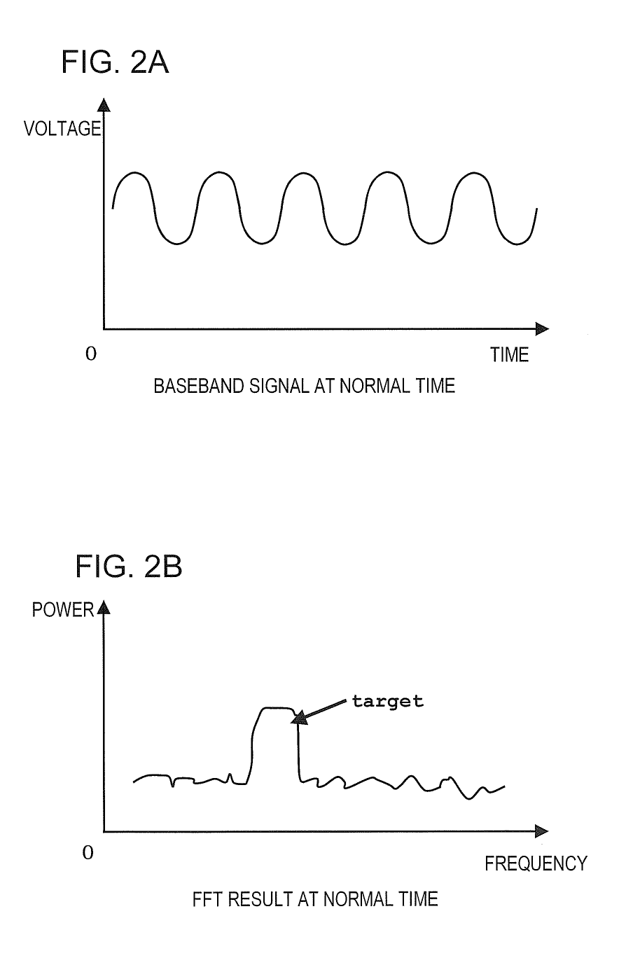

FIG. 2A shows an example of a baseband signal at normal time when there is no interference in the first and second receiving antennas 31, 32. The horizontal axis shows time, and the vertical axis shows voltage. In a received signal, which is received at normal time, the voltage gently fluctuates as time progresses, and this fluctuation is repeated on a certain cycle.

FIG. 2B shows an example in which the baseband signal is subjected to Fourier transformation. The horizontal axis shows frequencies, and the vertical axis shows power. At normal time, the power is the highest at a certain frequency, and, by detecting this frequency, the bearing, distance and the like of the target can be detected.

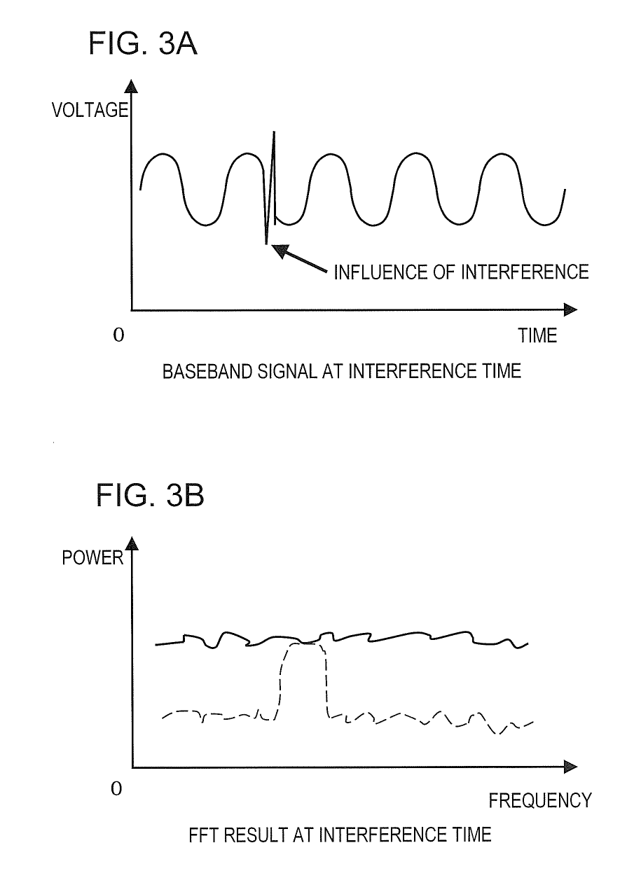

FIG. 3A shows an example of the baseband signal at the time when interference occurs. As shown in the figure, when interference occurs, the voltage drastically fluctuates at certain time due to the influence of the interference.

FIG. 3B shows an example in which this signal is subjected to Fourier transformation. When interference occurs, the power value remains at a substantially constant level as shown by the solid line. As the normal time shown by the dashed line, the frequency where the target exists cannot be detected.

The present embodiment focuses on a plan of taking a high power value as a whole by comparing the time when interference occurs with the time when no interference occurs. Also in the present embodiment the average value of the power values is maintained, and it is assumed that interference occurs when the difference between this average value and a previously detected average value exceeds a threshold value. Specifically, it is determined that interference occurs, when the amount of change in received power exceeds a certain threshold value.

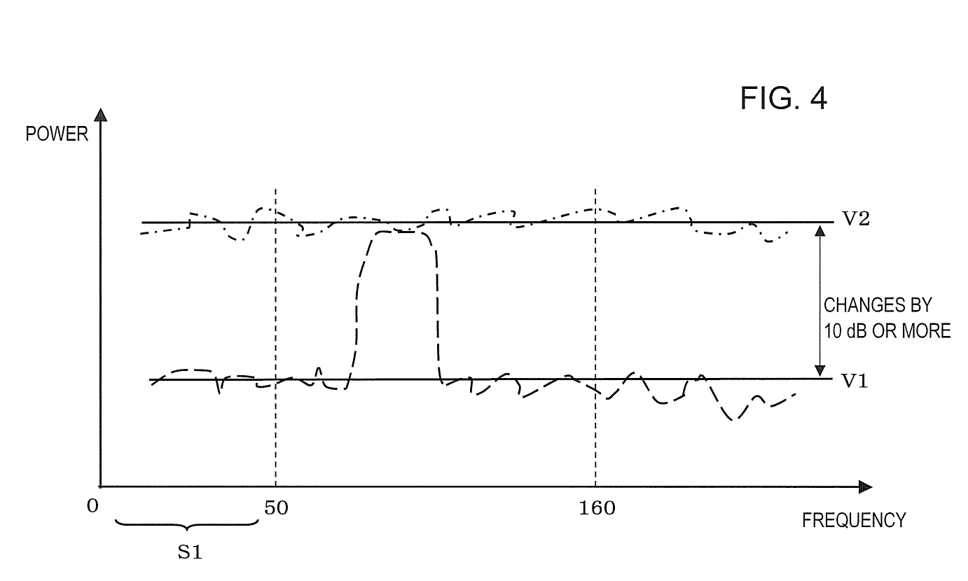

FIG. 4 is a figure showing an example of the above assumption. It is assumed that the average value of received power of a received signal is “V1” when a distribution shown by the dashed line is obtained from the received signal at certain time. Next, it is assumed that the average value of the received power of the received signal is “V2” when the received signal is detected and the distribution shown by the dashed-dotted line is obtained. When the difference between “V1” and “V2” is at least a threshold value of “10 dB”, it is determined that interference occurs in the receiving wave having the average value of “V2”. Of course, this threshold value is an example, thus other value may apply.

It should be noted that, instead of obtaining the average value from the power values of all frequencies, the average value may be obtained from power values within a range between, for example, “50 kHz” and “160 kHz”, in order to reduce the throughput. The throughput is reduced by narrowing the range of frequencies corresponding to a range S1 of “0 kHz” through “50 kHz” in which the power values are stable. On the other, the average value may be obtained from the power values in the range S1 of “0 kHz” through “50 kHz” in which the power values are stable.

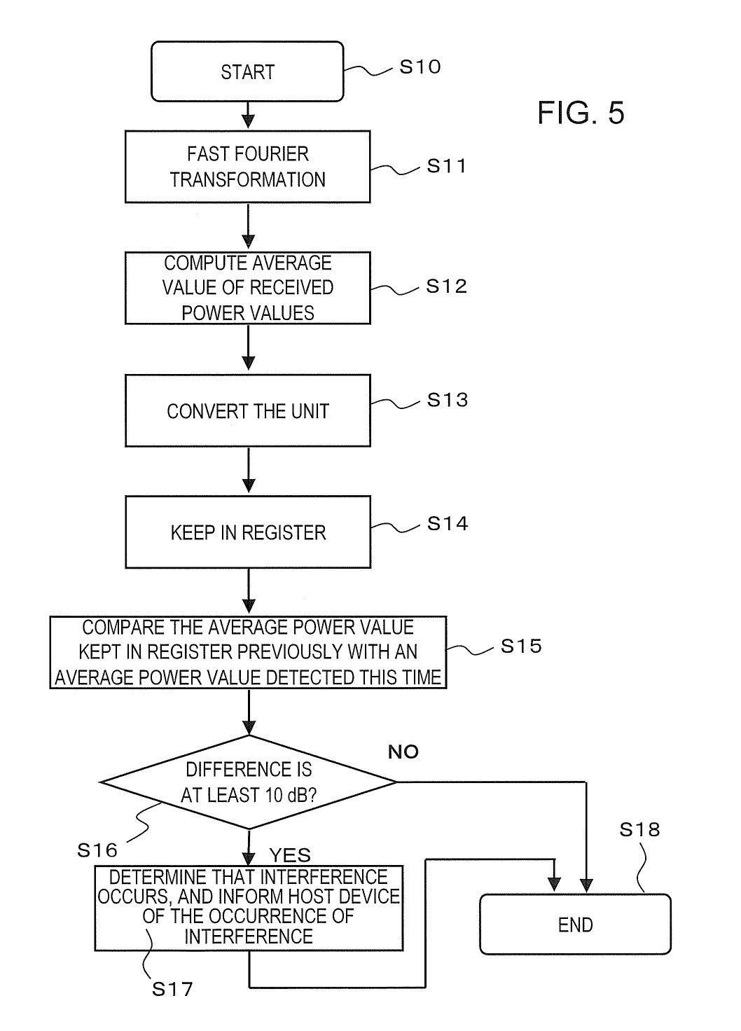

FIG. 5 shows an example of a flowchart which is executed by the interference detection unit 80. First, when the processing starts (S10), the interference detection unit 80 performs fast Fourier transformation on a received signal (S11).

Next, the interference detection unit 80 obtains the average value of the received power from the transformed received signal (S12). As described above, the average value is obtained from the received power values corresponding to the frequencies between, for example, “50 kHz” and “160 kHz”.

Next, the unit of the average value of the received power values is converted to “dB” (S13), and the value is kept in a register inside the interference detection unit 80 (S14). Not only the register, but also an external memory may be used to store the value.

The interference detection unit 80 then compares the average power value that is previously kept in the register, with an average power value that is detected this time (S15), and determines whether the difference between these average values is “10 dB” or higher (S16).

If the difference is “10 dB” or higher (YES), the interference detection unit 80 informs the host apparatus of the occurrence of interference in the received wave (S17). Then, the series of processes is ended (S18).

On the other hand, if the difference is lower than “10 dB” (NO in S16), the interference detection unit 80 determines that no interference occurs, and ends the series of processes without performing the process of S17.

As described above, in the present embodiment, interference is detected from the amount of change in the received power, thus interference can be detected accurately with simple configuration and without increasing the throughput.

It should be noted that detection time between when the average power value is computed and when the occurrence of interference is detected is, for example, “20 ms”.

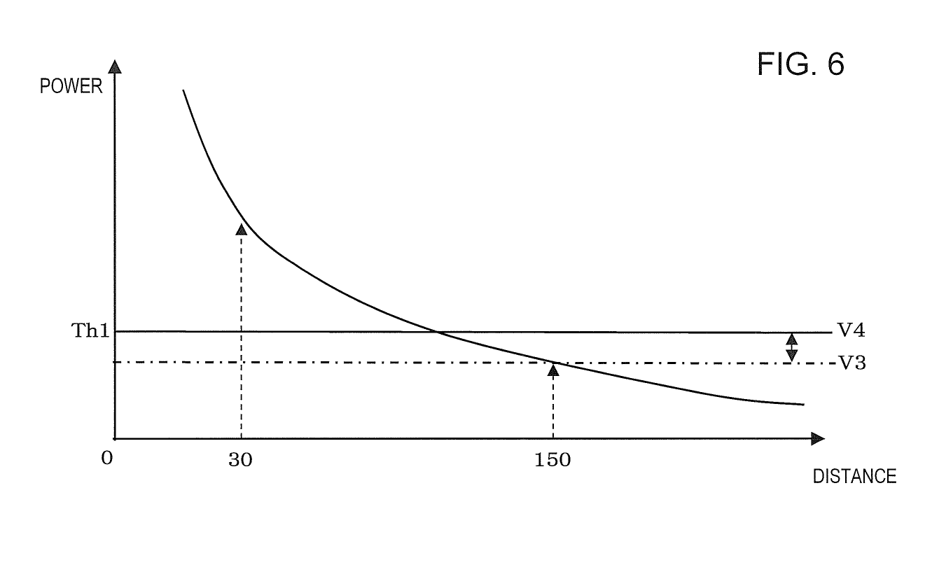

Next, other interference detection method is described. FIG. 6 is a figure showing the relationship between a distance and the received power. As shown in the figure, the received power of the received wave decreases as the distance between the radar apparatus 1 and the target increases.

On the other hand, since various circuits exist within the radar apparatus 1, circuit noise (DC noise) is generated. For example, as shown in FIG. 6, it is assumed that the circuit noise is a power value of “V3” (shown by the dashed-dotted line in the figure). A concrete example of “V3” is, for example, “−80 dBV”.

As shown in FIG. 6, due to this circuit noise, it is not possible to detect received power with the circuit noise or lower with respect to a distance of “150 m” or longer.

Therefore, the average value of the power values can be computed with this distance or longer, and thereby it is determined that interference occurs, when the power value of at least the circuit noise level is detected. In the example shown in FIG. 6, a margin is set in consideration of the circuit characteristics, and a power value of “Th1” is set as the threshold value. Specifically, it is determined that interference occurs, when the average value of the far received power is obtained and this average value is the threshold value “Th1” or higher.

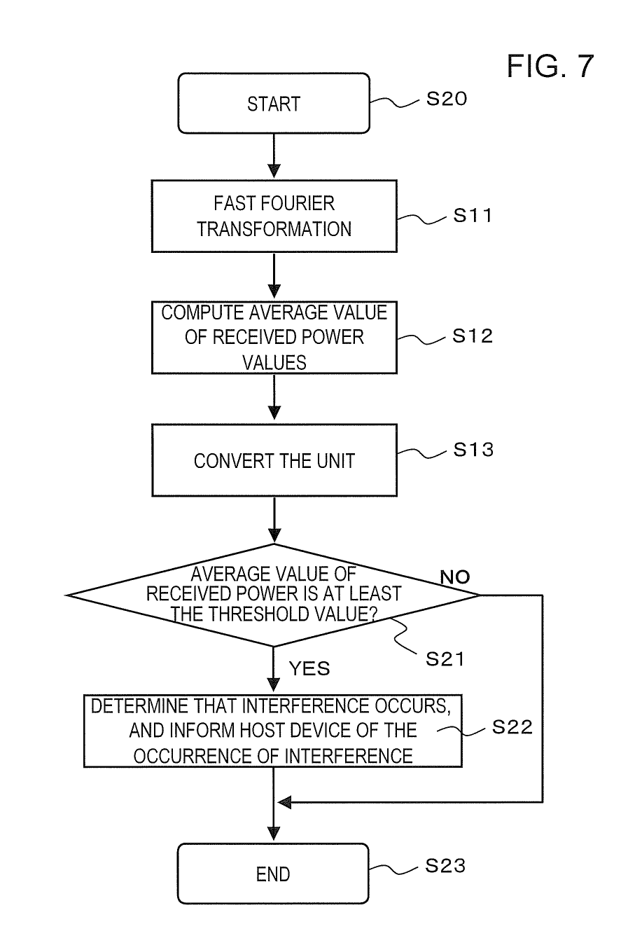

FIG. 7 shows an example of a flowchart which is executed by the interference detection unit 80. The same reference numerals are applied to the processes that are same as those shown in FIG. 5.

First, when the processing starts (S20), the interference detection unit 80 performs fast Fourier transformation on a received signal (S11), and computes the average value of far received power (S12).

In this case, “far” means a range between, for example, a frequency of “384 kHz” and a frequency of “511 kHz” in the figure shown in FIG. 4. The average value of the received power is obtained in this frequency range. Of course, other frequency range may be used.

Then, the interference detection unit 80 converts the unit of the power average value to “dB” (S13), and determines whether the value is the threshold value “Th1” or higher (S21). For example, the threshold value “Th1” is stored beforehand in a storage unit such as a memory inside or outside of the interference detection unit 80.

When the average value is the threshold value “Th1” or higher (YES), the interference detection unit 80 informs the host apparatus of the occurrence of interference (S22). Then, the series of processes is ended (S23).

On the other hand, if the average value is lower than the threshold value “Th1” (NO in S21), the interference detection unit 80 determines that no interference occurs, and ends the series of processes without performing the process of S22 (S23).

In interference detection of the present embodiment as well, interference is detected from the average value of the far received power, thus interference can be detected accurately with simple configuration and without increasing the throughput.

As with the example shown in FIG. 5, when the average value of the received power is obtained as the threshold value “Th1” or higher several times continuously, the host apparatus may be informed of the occurrence of interference.

Further, other interference detection method is described.

This embodiment describes a method in which transmission is not performed by the transmission antenna 20 and the interference detection unit 80 is used to monitor only received power of received waves sent from the first and second receiving antennas 31, 32, whereby it is determined that interference occurs when a predetermined received power value is obtained although transmission is not performed.

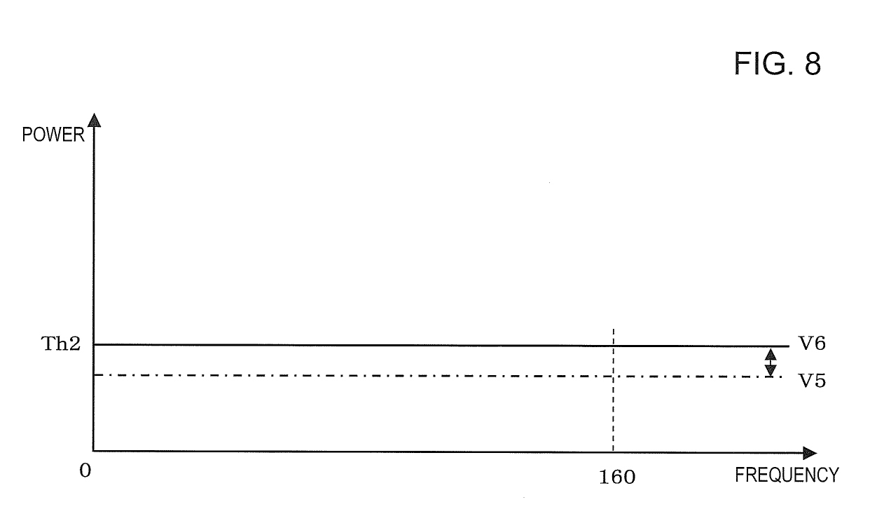

FIG. 8 is a figure showing an example of received power which is generated when transmission is not performed. When transmission is not performed, circuit noise is generated in the radar apparatus 1, thus the interference detection unit 80 detects received power “V5” (shown by the dashed-dotted line in the figure) by means of the noise.

Therefore, when the interference detection unit 80 detects received power that is larger than the abovementioned received power, the interference detection unit 80 can determine that an interfered wave is received.

In the example shown in FIG. 8, it is determined that interference occurs when a margin is set with respect to the circuit noise “V5” and power that is at least a power value “Th2” as the threshold value is obtained. The power value of the circuit noise is, for example, “−80 dBV”, and the threshold value is, for example, “−60 dBV”.

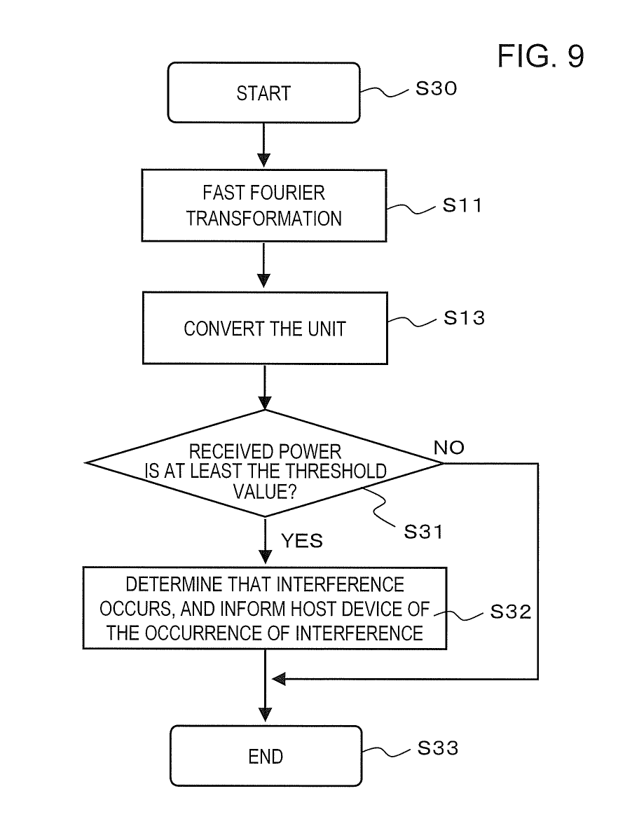

FIG. 9 shows an example of a flowchart which is executed by the interference detection unit 80. The same reference numerals are applied to the processes that are same as those shown in FIG. 5 and the like.

As the premise of the processing, the radar apparatus 1 is in the state in which a transmission wave is not transmitted from the transmission antenna 20. Such a state can be realized by, for example, the state in which a signal for forming a transmission wave is not outputted by the microcomputer or the like from the transmission wave generating unit 10, or by providing a switching switch between the transmission wave generating unit 10 and transmission antenna 20 and turning OFF this switch using the microcomputer or the like.

First, when the processing starts (S30), the interference detection unit 80 performs fast Fourier transformation on a received signal (S11). In this case, when the first and second receiving antennas 31, 32 do not receive an interfered wave, Fourier transformation is performed on a signal obtained from the circuit noise of each circuit (the mixer 50 and the like). For example, transformation is performed on the received signals having frequency between “20 kHz” and “160 kHz”.

Next, the interference detection unit 80 converts the unit of the received power to “dB” (S13), and determines whether thus obtained value is the threshold value “Th2” or higher (S31). When the received power value is the threshold value “Th2” or higher (YES), the interference detection unit 80 informs the host apparatus of the occurrence of interference (S32). Then, the series of processes is ended (S33).

On the other hand, if the received power is lower than the threshold value “Th2” (NO in S31), the interference detection unit 80 ends the processing without performing the process of S32 (S33).

As described above, only the received power is monitored without performing transmission and it is determined that interference occurs when the received power is larger than the threshold value “Th2”, thus interference can be detected accurately with simple configuration and without increasing the throughput.

In this embodiment, for example, the received power within the frequency range of “20 kHz” through “160 kHz” may be detected, and the maximum power value in this range may be compared with the threshold value “Th2”. Accordingly, the throughput can be further reduced, compared to the case where the power value is compared every time with the threshold value “Th2”.

Furthermore, a configuration is possible in which it is determined that interference occurs first, when the power value larger than the threshold value “Th2” is detected continuously several times (ten times, for example). Accordingly, the reliability of interference detection can be improved.

Further, other interference detection method is described.

This embodiment describes a method in which power within a range of high-relative velocities is monitored when a transmission wave is transmitted from the transmission antenna 20 at a certain frequency (at the time of a CW mode), and it is determined that an interfered wave is detected when the average value of the power is at least a threshold value.

In the case where the present radar apparatus 1 is mounted in a vehicle, it is impossible that the vehicle goes by an oncoming vehicle at a relative velocity of, for example, “300 km” or higher. When a certain level or more of received power value is detected within the range of high-relative velocities, it is determined that interference occurs.

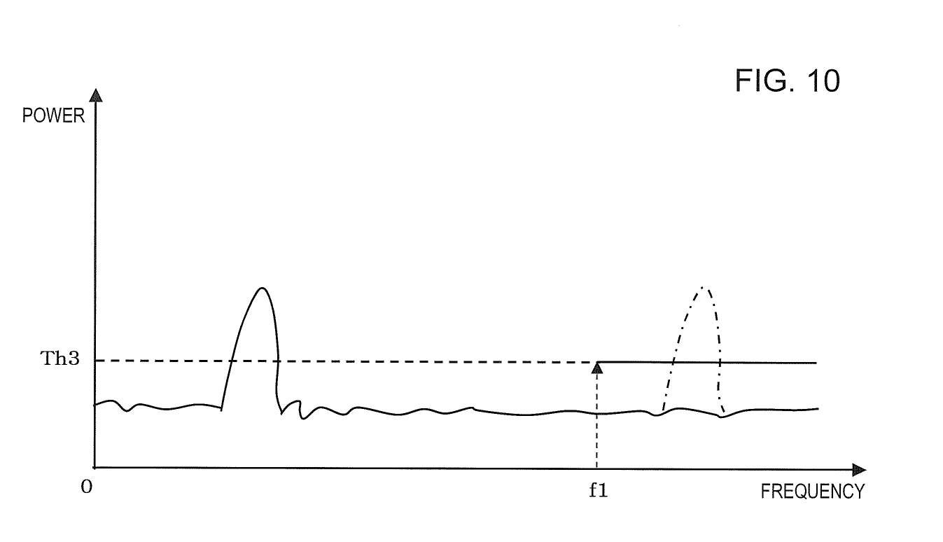

FIG. 10 shows an example of a distribution of the received power. At a frequency of “f1” corresponding to the relative velocity of “300 km”, only a certain level of received power is detected by the interference detection unit 80. This detection is due to the abovementioned circuit noise.

However, when interference occurs, received power at the level of circuit noise or higher is obtained within the range of high-relative velocities. As shown by the dashed-dotted line in FIG. 10, the obtained distribution is such that the maximum power value is obtained at a frequency higher than the frequency “f1”.

Therefore, it is determined that interference occurs, when a certain level of received power, which is at the level of the circuit noise or higher, is obtained within the frequency range of at least “f1”, and when, in the example of FIG. 10, a margin is set and received power of at least a threshold value “Th3” is obtained.

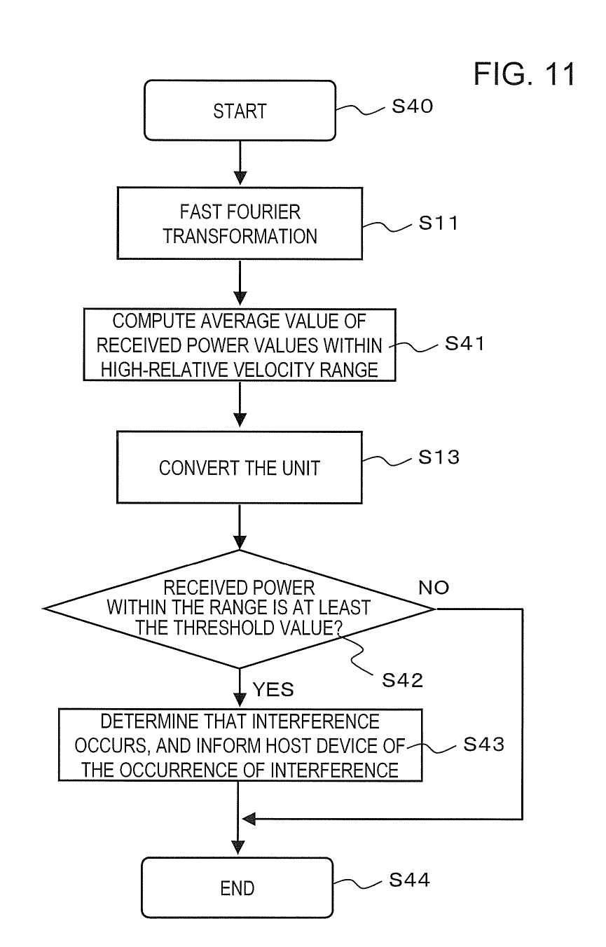

FIG. 11 is a figure showing an example of a flowchart according to the present embodiment. The same reference numerals are applied to the processes that are same as those shown in FIG. 5 and the like.

When the processing starts (S40), fast Fourier transformation is performed on a received signal (S11), and the average value of received power values is computed in a range of high-relative velocities of at least the frequency “f1” (S41).

Then, the unit of the computed average value is converted (S13), and the interference detection unit 80 determines whether the average value of the received power values within the abovementioned range is the threshold value “Th3” or higher (S42). If the average value is the threshold value “Th3” or higher (YES), the interference detection unit 80 determines that interference occurs, informs the host apparatus of the occurrence of interference (S43), and ends the series of processes (S44).

On the other hand, when the average value is lower than the threshold value “Th3” (NO in S42), the interference detection unit 80 determines that no interference occurs and ends the processing without performing the process of S43 (S44).

As described above, the occurrence of interference is detected from the received power values within the high-relative velocity range, thus interference can be detected accurately with simple configuration and without increasing the throughput.

It should be noted that in this embodiment determination is made based on that the received power of the circuit noise is “−80 dBV” and the threshold value “Th3” is “−60 dBV”. Of course, as with the abovementioned embodiments, various values may be used in accordance with the configuration of the radar apparatus 1.

Furthermore, in this example, as with the abovementioned embodiments, when the received power larger than the threshold value “Th3” is obtained continuously several times, it may be determined that interference occurs first. Accordingly, the reliability can be improved.

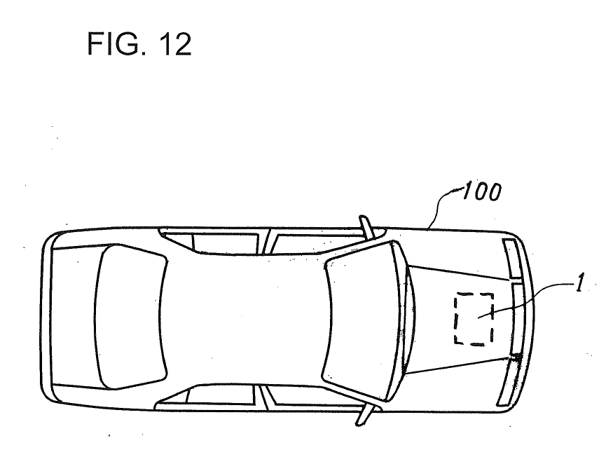

FIG. 12 shows an example in which the radar apparatus 1 of the present invention is mounted in a vehicle 100. In this case as well, operational effects that are same as those of the above embodiments can be achieved. It should be noted in the example shown in FIG. 12 that although the radar apparatus 1 is mounted in the vicinity of the center at the front of the vehicle, of course, the radar apparatus 1 may be mounted in any place inside the vehicle 100.

### Embodiment 2

Embodiment 2 is described next. Embodiment 1 above has described the radar apparatus 1 in which the two receiving antennas 31, 32 detect interference. For example, the received signal that is received by the first receiving antenna 31 is switched by the output switching switch 60 to be outputted to the first ADC 71. Also, the received signal that is received by the second receiving antenna 32 is switched by the output switching switch 60 to be outputted to the second ADC 72. The interference detection unit 80 or host apparatus can also detect a phase difference between the received signal outputted from the first ADC 71 and the received signal outputted from the second ADC 72. Therefore, in Embodiment 1 the bearing of the target can be also detected by detecting this phase difference.

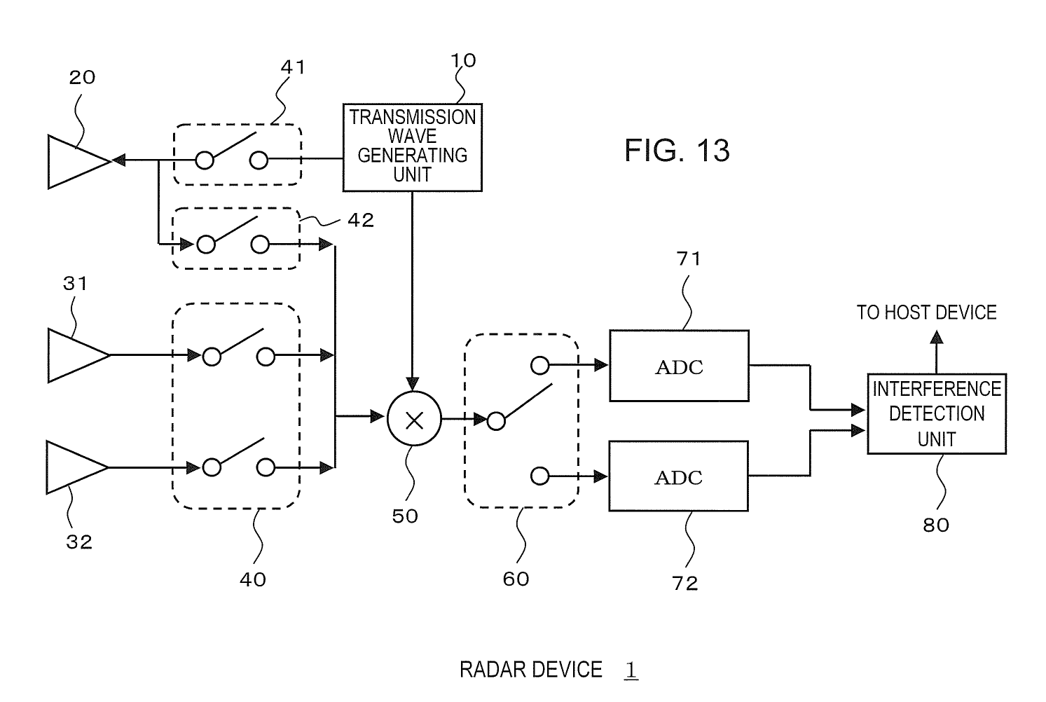

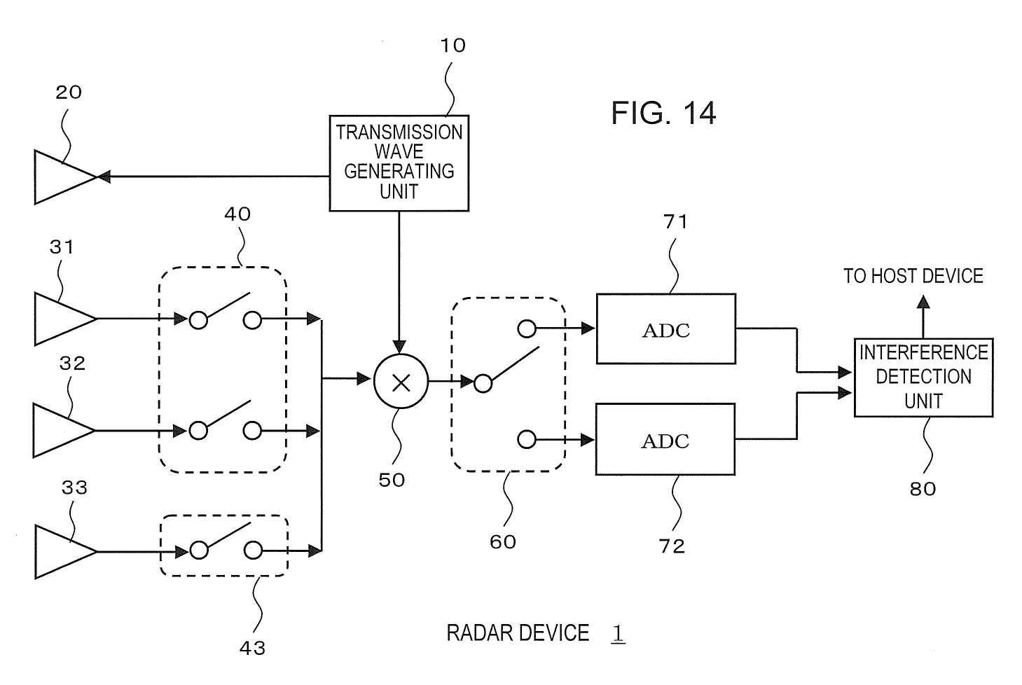

FIG. 13 and FIG. 14 are figures, each showing a configuration example of the radar apparatus 1 in this Embodiment 2. As shown in FIG. 13, in the radar apparatus 1 according to Embodiment 2, the antenna 20 serves as both transmission and receiving antennas, and second and third antenna switching switches 41, 42 are newly added to the radar apparatus 1 of Embodiment 1. It should be noted that the antenna switching switch 40 is referred to as “a first antenna switching switch” in Embodiment 2.

When the transmission and receiving antenna 20 functions as a transmission antenna the second antenna switching switch 41 is turned ON, and when the transmission and receiving antenna 20 functions as a receiving antenna the third antenna switching switch 42 is turned ON. The switching ON and OFF of these switches is controlled by the microcomputer, which is the host apparatus.

Further, three switches of the third antenna switching switch 42 and the first antenna switching switch 40 are not turned ON at the same time. When any one of three switches is turned ON, the output switching switch 60 is switched to be connected to any one of the first or second ADC 71, 72. As with Embodiment 1, the switching ON and OFF of the switch is controlled by the microcomputer, which is the host apparatus.

An output signal from the first ADC and an output signal from the second ADC 72 are inputted to the interference detection unit 80, whereby interference is detected from these two output signals. The method of detecting interference is exactly the same as the one described in the first embodiment.

Specifically, the interference detection unit 80 executes the method of detecting interference by comparing the average power value that is previously kept in the register, with a newly detected average power value (see FIG. 5 and the like), the method of detecting interference by using an average value of received power corresponding to a large distance (see FIG. 7 and the like), the method of detecting interference by using a received power value obtained when a transmission wave is not transmitted (see FIG. 9 and the like), and the method of detecting interference by using an average value of received power corresponding to a high-relative velocity range (see FIG. 11 and the like).

Therefore, in this Embodiment 2 as well, as with Embodiment 1, the radar apparatus 1 that has a simple configuration and is capable of accurately detecting interference without increasing the throughput can be provided.

Moreover, in Embodiment 2, when the transmission and receiving antenna 20 is caused to function as the receiving antenna, the target is detected by the three receiving antennas 20, 31, 32. Specifically, the distances between the three receiving antennas 20, 31, 32 are determined according to wavelengths λ of received signals without generating a folded phase, but since these receiving antennas are installed at different distances, received signals are detected with different phase differences. Then, since the lower part of the interference detection unit 80 or host apparatus detects the bearing and the like of the target based on these different phase differences, the chance of accurately detecting the bearing is higher compared to Embodiment 1 where the two receiving antennas 31, 32 are used.

FIG. 14 also is a figure showing another configuration example of the radar apparatus. In this radar apparatus 1, the antenna 20 is for transmission only, and a third receiving antenna 33 and a fourth output switching switch 43 are newly provided. As with the radar apparatus 1 shown in FIG. 13, interference is detected by the three receiving antennas 31 through 33 and the like to detect the bearing of the target.

Therefore, the radar apparatus 1 shown in FIG. 14 also has a simple configuration and is capable of accurately detecting interference without increasing the throughput, thus the chance of accurately detecting the bearing of the target is high.

What is claimed is:

1. A radar apparatus; comprising,
a transmit antenna which transmits a transmit wave,
a receive antenna which receives a receive wave including a reflected wave reflected on a target of the transmit wave; and
an interference detection unit which judges that interference has occurred, when received power obtained by performing Fourier transformation on the receive wave received by the receive antenna changed by a threshold value or more.

2. The radar apparatus according to claim 1, wherein the interference detection unit judges that interference has occurred, when a difference between an average value of the received power of the receive wave and an average value of the received power of the previously detected receive wave changes by a threshold value or more.

3. An interference detection method for a radar apparatus comprising a transmit antenna which transmits a transmit wave, and a receive antenna which receives a receive wave including a reflected wave reflected on a target of the transmit wave, the method comprising the step of:
judging that interference has occurred, when received power of the receive wave received by the receive antenna changes by a threshold value or more.

4. An interference detection method for a radar apparatus comprising a transmit antenna which transmits a transmit wave, and a receive antenna which receives a receive wave including a reflected wave reflected on a target of the transmit wave, the method comprising the step of:
judging that interference has occurred, when, of the receive waves received by the receive antenna, an average value of received power corresponding to a large distance from the radar apparatus is a threshold value or more.

5. An interference detection method for a radar apparatus comprising a transmit antenna which transmits a transmit wave, and a receive antenna which receives a receive wave including a reflected wave reflected on a target of the transmit wave, the method comprising the step of:
judging that interference has occurred, if a received power value, when the transmit wave is not transmitted from the transmit antenna, is a threshold value or more.

6. An interference detection method for a radar apparatus comprising a transmit antenna which transmits a transmit wave, and a receive antenna which receives a receive wave including a reflected wave reflected on a target of the transmit wave, the method comprising the step of:
judging that interference has occurred, when, of the receive waves received by the receive antenna, an average value of received power corresponding to a high-relative velocity range is a threshold value or more.
